(19) United States
(12) Patent Application Publication
(10) Pub. No.: US 2012/0128255 A1
(43) Pub. Date: May 24, 2012

(54) PART DETECTION APPARATUS, PART DETECTION METHOD, AND PROGRAM

(75) Inventors: Kazumi Aoyama, Saitama (JP); Katsuki Minamino, Tokyo (JP); Atsushi Okubo, Tokyo (JP)

(73) Assignee: SONY CORPORATION, Tokyo (JP)

(21) Appl. No.: 13/275,543

(22) Filed: Oct. 18, 2011

(30) Foreign Application Priority Data
Nov. 22, 2010 (JP) 2010-260194

(51) Int. Cl. G06K 9/46

(52) U.S. Cl. 382/195

(57) ABSTRACT

The present disclosure provides a part detection apparatus including, a part detection block configured to detect a location of a plurality of parts making up a subject from an input image, and a part-in-attention estimation block configured, if a location of a part in attention has not been detected by the part detection block, to estimate the location of a part in attention on the basis of the location of a part detected by the part detection block and information about a locational relation with the detected location of a part being used as reference.

### BACKGROUND

The present disclosure relates to a part detection apparatus, a part detection method, and a program.

Recently, technologies called face detection have been drawing attention. Face detection denotes the analysis of an image and the mechanical detection of the face of a person contained the analyzed image. To be more detail, the features of the face of a particular person are stored and an area having the features substantially similar to the stored feature is detected from an image. For example, Japanese Patent Laid-open No. 2009-140369 (hereinafter referred to as Patent Document 1) discloses a method of applying boosting technologies to face detection processing. Boosting technologies are intended to realize a precision feature quantity detector (or a strong detector) by use of many simple feature quantity detectors (or weak detectors) in a collective manner. Use of the technologies disclosed in Patent Document 1 allows the detection of a person's face from an image with a high accuracy.

### SUMMARY

However, it is difficult for the face detection technologies disclosed in Patent Document 1 above to detect a face if most of the face is hidden behind a blocking object or the face is completely directed sideways. Therefore, the present disclosure addresses the above-identified and other problems associated with related-art methods and apparatuses and solves the addressed problems by providing a part detection apparatus, a part detection method, and a program that are configured to estimate the location of a face undetectable by the face detection processing, in a novel and improved manner. It should be noted that the face detection technologies disclosed in Patent Document 1 can be extended part detection technologies for detecting parts other than the face. In consideration of this technological extension, embodiments of the present disclosure can be extended to a degree that a part detection apparatus, a part detection method, and a program that are configured to estimate the location of parts that cannot be detected by the above-mentioned related-art technologies are provided.

In carrying out the invention and according to one embodiment thereof, there is provided a part detection apparatus. This part detection apparatus has a part detection block configured to detect a location of a plurality of parts making up a subject from an input image and a part-in-attention estimation block configured, if a location of a part in attention has not been detected by the part detection block, to estimate the location of a part in attention on the basis of the location of a part detected by the part detection block and information about a locational relation with the detected location of a part being used as reference.

The above-mentioned part detection apparatus further has an information update block configured, if the location of a part in attention and a location of a part different from the part in attention have been detected by the part detection block, to update the information about a locational relation on the basis of the location of a part in attention and the location of another part.

In the above-mentioned part detection apparatus, the part detection block detects the locations of a plurality of parts with a first accuracy and, if the location of a part in attention has not been detected, detects the location of a plurality of parts with a second accuracy higher than the first accuracy for an area having a predetermined size including the location of a part in attention estimated by the part-in-attention estimation block.

The above-mentioned part detection apparatus still further has an identification information allocation block configured to allocate different identification information for each of the subjects to the parts of which locations have been detected by the part detection block. In this case, this identification information allocation block allocates substantially the same identification information as the identification information allocated to the part used for estimation to the part in attention of which location has been estimated by the part-in-attention estimation block.

In the above-mentioned part detection apparatus, the input image is a frame making up a moving image. The above-mentioned part detection apparatus yet further has a tracking block configured to track the location of a part in attention.

In the above-mentioned part detection apparatus, if the location of a part in attention has not been detected by the part detection block but locations of a plurality of parts different from the part in attention have been detected, then the part-in-attention estimation block estimates the location of a part in attention on the basis of the locations of a plurality of parts detected by the part detection block and information about a locational relation with the detected locations of a plurality of parts being used as reference.

The above-mentioned part detection apparatus further has an attribute detection block configured to detect attributes of the subject from a predetermined part detected by the part detection block. In this case, the part-in-attention estimation block references the information about a locational relation prepared for each of the attributes to estimate the location of a part in attention on the basis of the information about locational relation corresponding to the attribute of the subject detected by the attribute detection block.

In carrying out the disclosure and according to another embodiment thereof, there is provided a part detection method. This part detection method has the steps of detecting a location of a plurality of parts making up a subject from an input image and estimating, if a location of a part in attention has not been detected by the part detection block, the location of a part in attention on the basis of the location of a part detected by the part detection block and information about a locational relation with the detected location of a part being used as reference.

In carrying out the disclosure and according to still another embodiment thereof, there is provided a program for causing a computer to realize the functions of detecting a location of a plurality of parts making up a subject from an input image and estimating, if a location of a part in attention has not been detected by the part detection block, the location of a part in attention on the basis of the location of a part detected by the part detection block and information about a locational relation with the detected location of a part being used as reference. Further, in carrying out the disclosure and according to yet another embodiment thereof, there is provided a computer-readable recording media in which the above-mentioned program is recorded.

As described above and according to the embodiments of the present disclosure, the location of a part that could not be detected by a detector configured to detect a part of a subject by analyzing features of an image can be estimated.

### BRIEF DESCRIPTION OF THE DRAWINGS

FIG. 1 is a schematic diagram illustrating an exemplary functional configuration of a part detection apparatus practiced as one embodiment of the disclosure;

FIG. 2 shows diagrams for describing a face detection method that is one example of a part detection method practiced as one embodiment of the disclosure;

FIG. 3 shows diagrams for describing the face detection method that is one example of the part detection method practiced as the above-mentioned embodiment;

FIG. 4 is a diagram for describing a part estimation method practiced as one embodiment of the disclosure;

FIG. 5 is a diagram for describing the part estimation method practiced as the above-mentioned embodiment;

FIG. 6 is a flowchart indicative of part detection processing associated with the embodiment shown in FIG. 1;

FIG. 7 is a flowchart continued from the flowchart shown in FIG. 6;

FIG. 8 is a schematic diagram illustrating an exemplary functional diagram of an object tracking apparatus that is one exemplary application of the part detection apparatus shown in FIG. 1;

FIG. 9 is a flowchart indicative of tracking processing associated one embodiment of the disclosure;

FIG. 10 is a schematic diagram illustrating an exemplary functional configuration of a part detection apparatus practiced as a variation (or a first variation) to the embodiment shown in FIG. 1;

FIG. 11 is a flowchart indicative of part detection processing associated with the variation shown in FIG. 10;

FIG. 12 is a diagram for describing a part estimation method practiced as a variation (or a second variation) associated with the embodiment shown in FIG. 10;

FIG. 13 is a flowchart indicative of part estimation processing associated with the variation shown in FIG. 10;

FIG. 14 is a flowchart continued from the flowchart shown in FIG. 13;

FIG. 15 is a flowchart continued from the flowchart shown in FIG. 13 and FIG. 14; and

FIG. 16 is a block diagram illustrating an exemplary hardware configuration of an information processing apparatus configured to realize the functions of the part detection apparatuses and the object tracking apparatus shown in FIGS. 1 and 11 and FIG. 8, respectively.

### DETAILED DESCRIPTION OF THE PREFERRED EMBODIMENTS

This disclosure will be described in further detail by way of embodiments thereof with reference to the accompanying drawings. It should be noted that components having substantially the similar functional configurations are denoted by the same reference numerals and the duplicate description thereof will be omitted.

### [Description Flows]

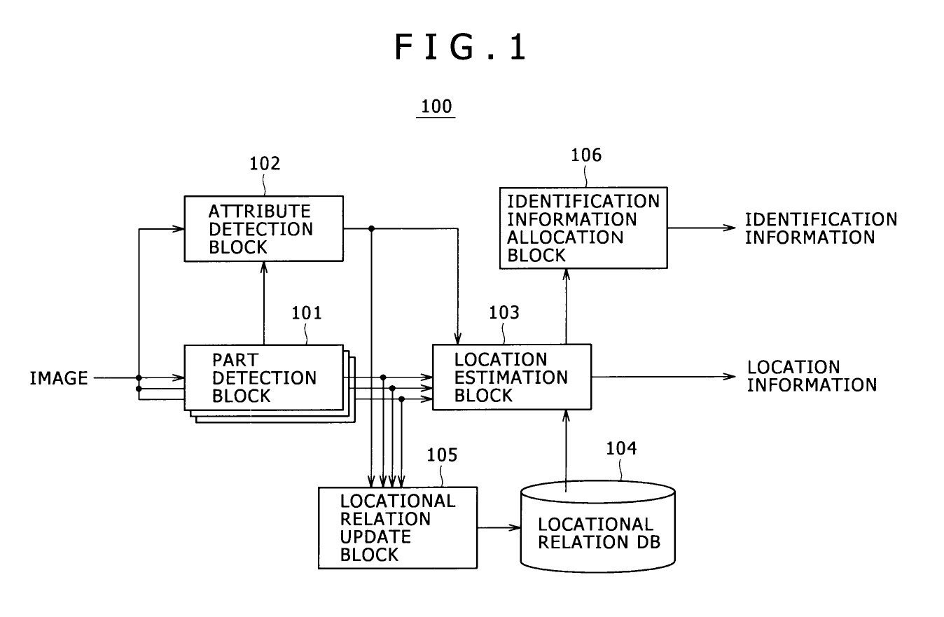

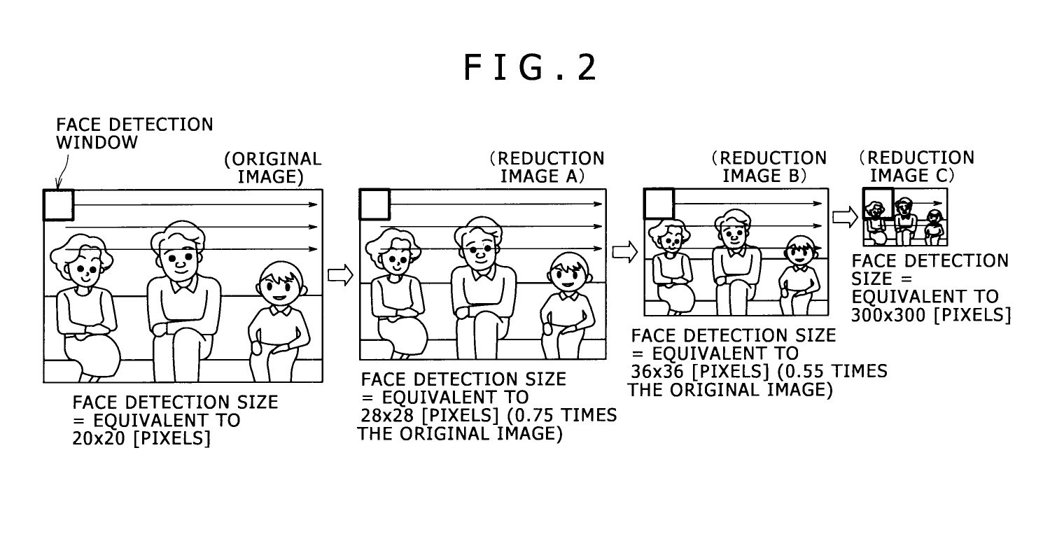

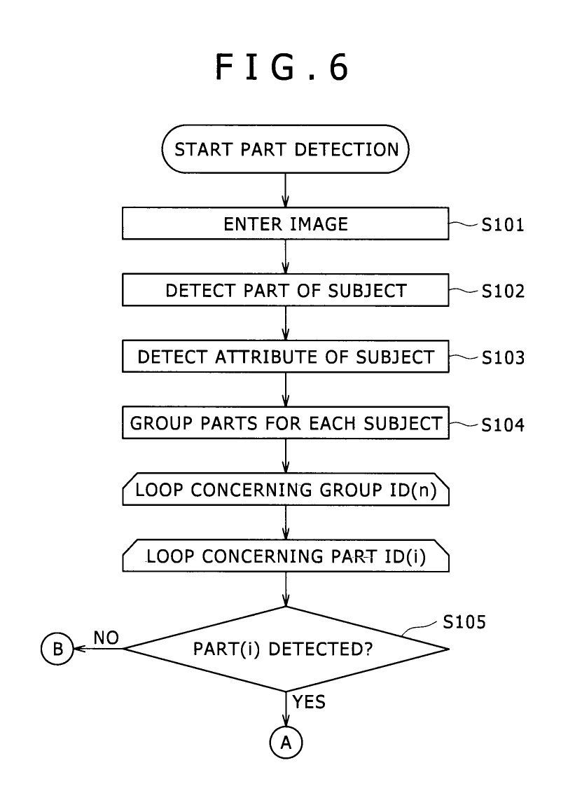

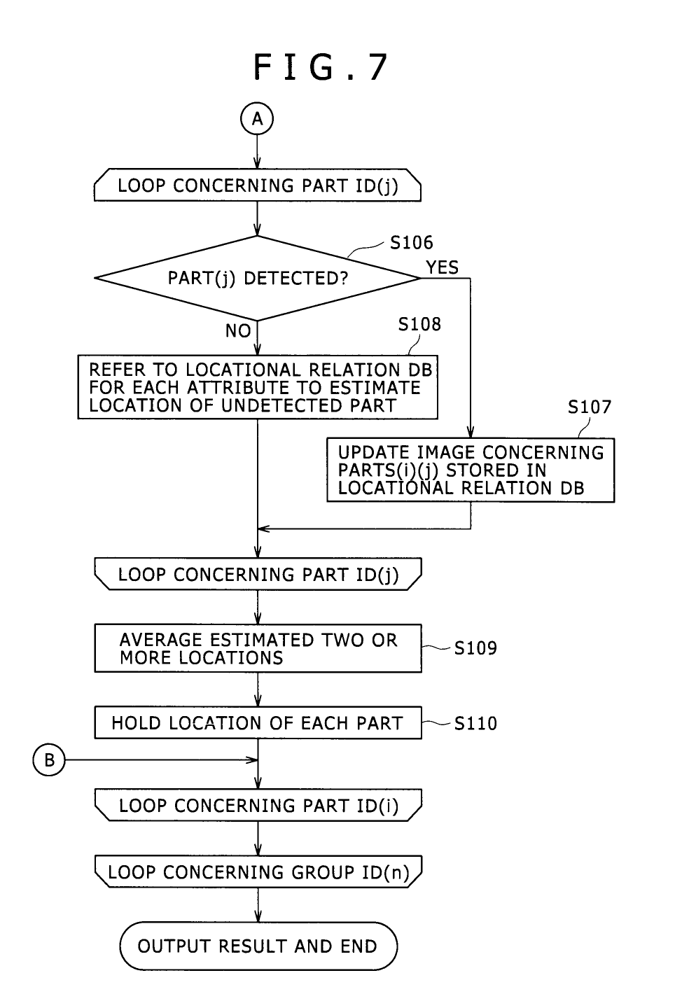

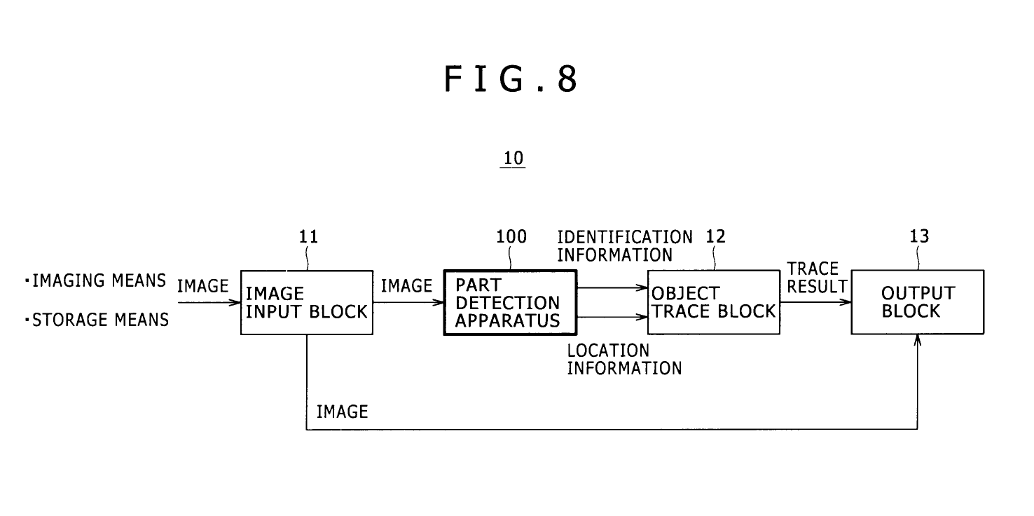

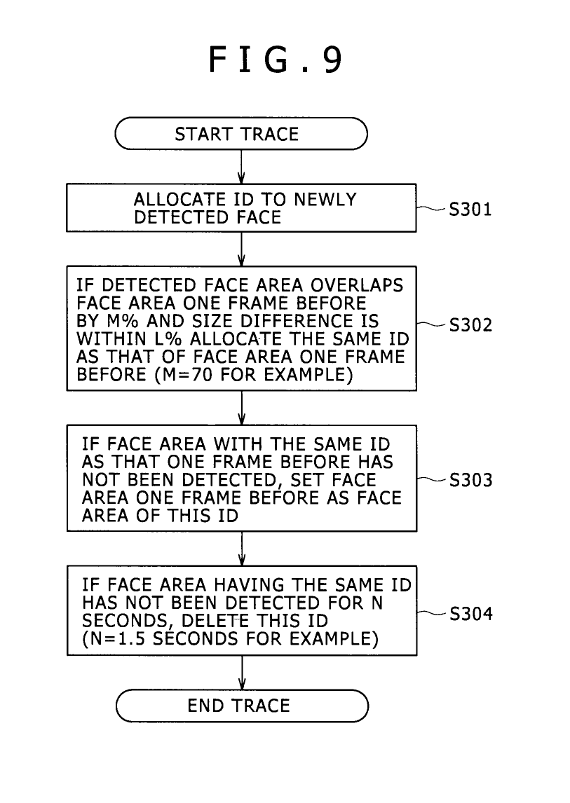

The following briefly describes the flows of description associated with embodiments of the present disclosure. First, referring to FIG. 1, an exemplary functional configuration of a part detection apparatus 100 practiced as one embodiment of the present disclosure will be described. At the same time, a part detection method and a part estimation method associated with the above-mentioned embodiment will be described with reference to FIG. 2 through FIG. 5. Next, operations to be executed by the part detection apparatus 100 practiced as the above-mentioned embodiment will be described with reference to FIG. 6 and FIG. 7. In addition, an exemplary functional configuration of an object tracking apparatus 10 that is an exemplary application of the part detection apparatus 100 of the above-mentioned embodiment will be described with reference to FIG. 8. Further, a flow of face tracking processing associated with the above-mentioned embodiment will be described with reference to FIG. 9.

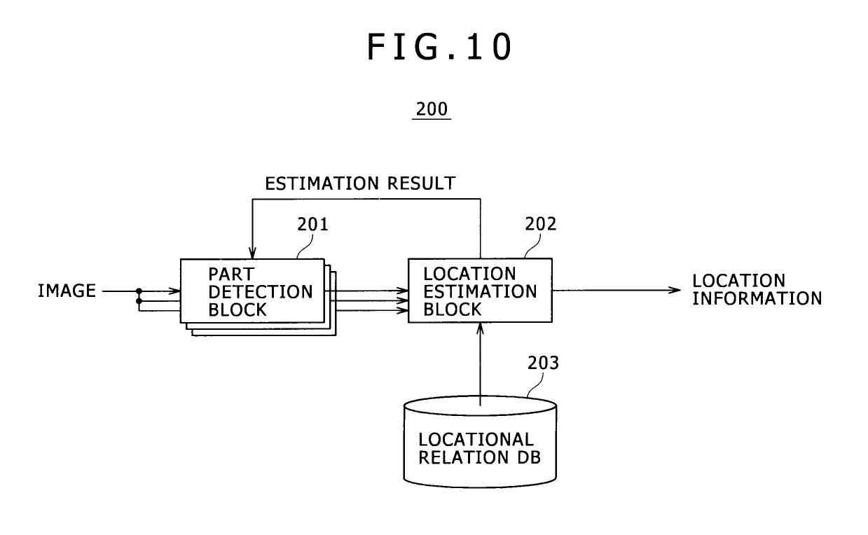

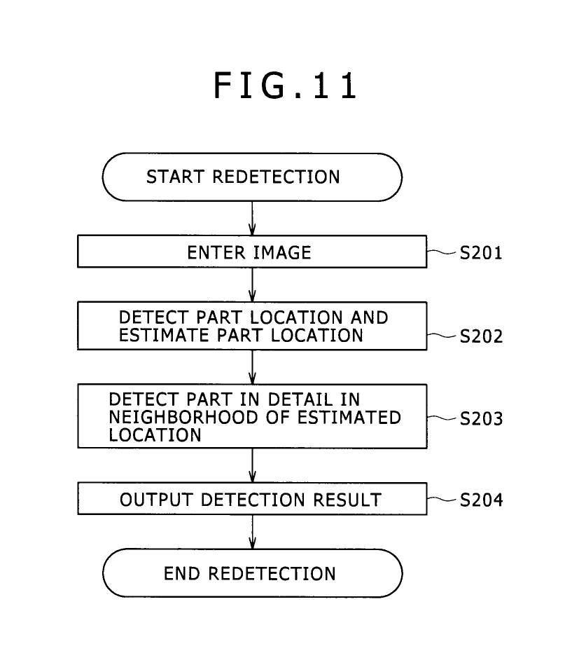

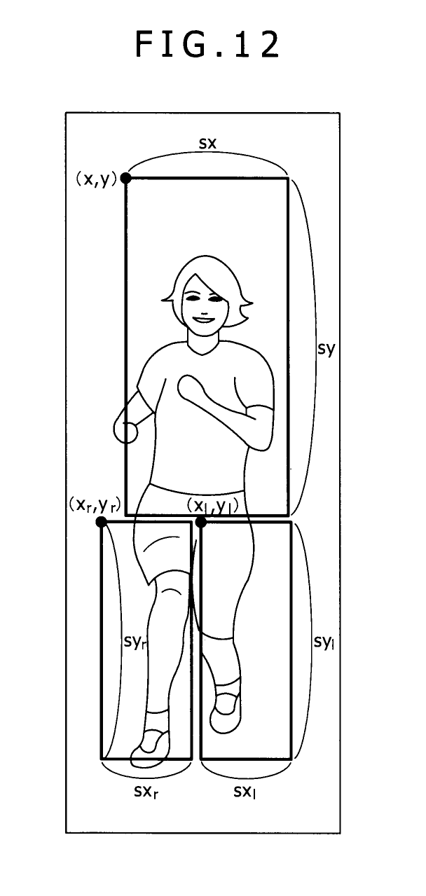

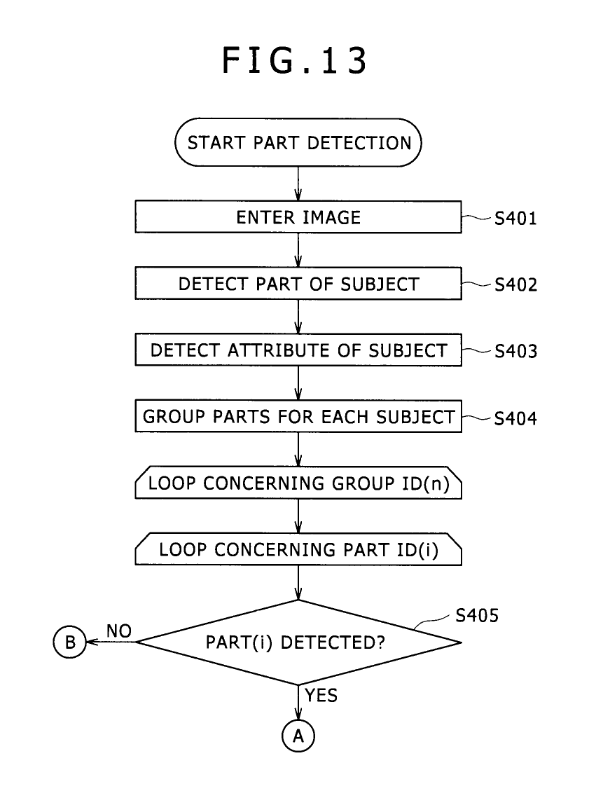

Next, an exemplary functional configuration of a part detection apparatus 200 practiced as one variation (or a first variation) to the embodiment shown in FIG. 1 will be described with reference to FIG. 10. Then, operations to be executed by a part detection apparatus 200 practiced as a variation to the above-mentioned embodiment will be described with reference to FIG. 11. At the same time, flows of part detection processing associated with this variation will be descried in detail. Further, a part estimation method practiced as one variation (or a second variation) to the above-mentioned embodiment will be described with reference to FIG. 12. Next, flows of part detection processing associated with the variation shown in FIG. 10 will be described with reference to FIG. 13 through FIG. 15.

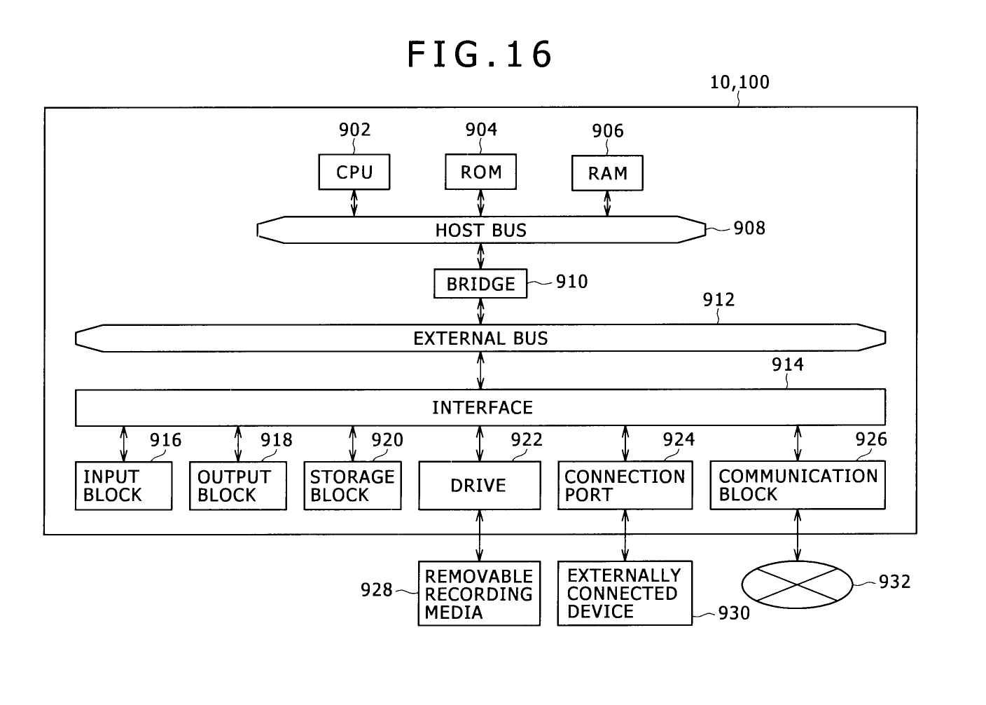

Then, an exemplary hardware configuration configured to realize the functions of the part detection apparatus 100, the part detection apparatus 200, and the object tracking apparatus 10 practiced as the above-mentioned embodiments will be described with reference to FIG. 16. Lastly, the technological concepts associated with the above-mentioned embodiments of the disclosure will be summarized and the effects that can be obtained from these technological concepts will be briefly described.

### (Description Items)

1: Embodiments

1-1: Exemplary functional configuration of the part detection apparatus 100

1-2: Operations of the part detection apparatus 100

1-3: Exemplary configuration and operations of the object tracking apparatus 10

1-4: The first variation (stepwise detection processing)

1-4-1: Exemplary functional configuration of the part detection apparatus 200

1-4-2: Operations of the part detection apparatus 200

1-5: The second variation (part estimation by two or more parts

1-5-1: Overview of an estimation method

1-5-2: Flows of part estimation processing

2: Exemplary hardware configuration

3: Summary

### 1: Embodiments

The following describes embodiments of the present disclosure. The present embodiment is associated with a part detection method configured to analyze an image to detect parts making up a subject in the image. Especially, the present embodiment is associated with a part estimation method configured, if a part or parts making up a subject could not be detected by some reason, to estimate the locations of the part or parts not detected from the locations of the parts detected. The following describes in detail the part detection method and the part estimation method practiced as embodiments of the disclosure.

### [1-1: Exemplary Functional Configuration of the Part Detection Apparatus 100]

Now, referring to FIG. 1, an exemplary functional configuration of the part detection apparatus 100 configured to realize the part detection method and the part estimation method associated with embodiments of the disclosure will be described. FIG. 1 is a schematic diagram illustrating an exemplary functional configuration of the part detection apparatus 100 practiced as one embodiment of the disclosure.

As shown in FIG. 1, the part detection apparatus 100 is mainly configured by two or more part detection blocks 101, an attribute detection block 102, a location estimation block 103, a locational relation database 104, a locational relation update block 105, and an identification information allocation block 106. It should be noted that, depending on how the part detection apparatus 100 is used, the attribute detection block 102, the locational relation update block 105 and/or identification information allocation block 106 may be omitted or the configuration of the locational relation database 104 may be changed. For example, if still images are entered in the part detection apparatus 100, the locational relation update block 105 and the identification information allocation block 106 may be omitted.

### (Function of the Part Detection Block 101)

The part detection apparatus 100 has the two or more part detection blocks 101 configured to separately detect different parts. For example, the part detection apparatus 100 has the part detection block 101 configured to detect a human (or person's) face, the part detection block 101 configured to detect a human upper-half body, and the part detection block 101 configured to detect a human right leg. In addition, the part detection apparatus 100 may have the part detection block 101 configured to detect a personal hand, an automobile's tire or body, or an animal's tail, for example. It should also be noted that there are three part detection blocks 101 in FIG. 1 but the number of part detection blocks 101 may be two or four or more.

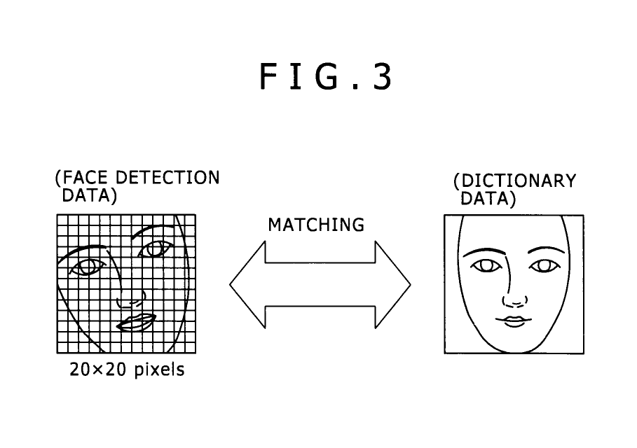

The following describes the basic mechanism of the part detection to be executed by the part detection blocks 101 with reference to FIG. 2 and FIG. 3. It should be noted that, for the convenience of description, the following describes an example of face detection to be executed by the part detection block 101 configured to detect a person's face.

When an image subject to face detection is entered, the part detection block 101 scans the entered image with a frame (hereafter referred to as a face detection window) having a predetermined size as shown in FIG. 2. At this moment, the part detection block 101 compares the image (or face detection data) in a area enclosed by the face detection window with a prepared reference image (or dictionary image data) while moving the face detection window by a predetermined moving amount as shown in FIG. 3. If, as a result of the comparison, the image enclosed by the face detection window is found to be a person's face, then the part detection block 101 outputs the location of the face detection window as a face detection result.

In addition, the part detection block 101 repeats the scan of the image by the face detection window while gradually reducing the size of the image as shown in FIG. 2. By reducing the image without reducing the size of the face detection window, a person's face can be detected with various resolutions. For example, if the size of the face detection window is set to 20×20 pixels and the original image is set to ×0.75 (reduced image A) as shown in FIG. 2, then the size of the face detection window is equivalent to 28×28 pixels in original image conversion. It should be noted that this example is a method of scanning an image by gradually reducing the image; it is also practicable to use a method of repeating the scan of an image while gradually varying the size of the face detection window.

In addition, a method is disclosed in Patent Document 1, for example, in which whether an image in an area enclosed by the face detection window is a person's face or not can be determined with high accuracy. In this method, many images predetermined to person's faces or not are prepared as learning data to build a decision device by the mechanical learning based on the prepared learning data. Especially, this method is intended to build a strong detector by collectively using many weak detectors. Obviously, the part detection block 101 may execute face image decision by another method; however, using this method allows the face image decision with higher accuracy. It should be noted, however, that it is difficult for this method to detect, as a person's face, a face that is mostly hidden by a blocking object or a face that is completely directed sideways.

It should also be noted that the accuracy of face detection also depends on the moving amount of the face detection window or the reduction factor of each image. For example, scanning an image by finely moving the face detection window reduces the chance of dropped detection, thereby enhancing the accuracy of face detection. However, the lower the moving amount of the face detection window, the higher the number of times face decision processing accordingly, thereby leasing to an increased amount of computational operation. Likewise, the smaller the image reduction factor, the higher the amount of computational operation. Therefore, the moving amount of the face detection window and the reduction factor of each image are determined by considering the balance between the accuracy and the computational operation of face detection. Hence, the accuracy of face detection may have been set to low levels in advance. In this case, due to a lower accuracy, a face detection may fail in an area in which a face should be detected.

As described above, the part detection block 101 can detect part locations from an image by use of the mechanism described above. Each part location detected by the part detection block 101 is entered in the locational estimation block 103 and the locational relation update block 105 as a result of the part detection. If the part detection fails, the part detection block 101 enters a detection result indicative that a part has not been detected into the locational estimation block 103 and the locational relation update block 105. In addition, if a predetermined part has been detected, the part detection block 101 configured to detect a predetermined part (a face for example) enters the location of the detected part into the attribute detection block 102 as a result of the part detection.

It should be noted that term “location” of a part as used herein sometimes denotes information that includes both the location and the shape of an image area detected as a part. For example, if an image area is rectangular, then information including both the location in an image indicated by the vertex coordinate or the center coordinate of the image area and the shape indicated by the width and height of image area may be expressed as a “location.” Obviously, the shape of each image area may be other than a rectangle.

### (Function of the Attribute Detection Block 102)

As described above, a result of the part detection associated with a predetermined part is entered in the attribute detection block 102 from the part detection block 101. In addition, the same image as entered in the part detection block 101 is entered in the attribute detection block 102. When a part detection result (a part location) and an image are entered in the attribute detection block 102, the attribute detection block 102 extracts an image of a predetermined part (hereafter referred to as an attribute detection image) from the entered image. Then, the attribute detection block 102 analyzes the attribute detection image to detect the attribute of a subject having the predetermined part. It should be noted that the attribute detected by the attribute detection block 102 is entered in the locational estimation block 103 and the locational relation update block 105.

For example, if the subject is a person, the attributes thereof are race, gender, age, having glasses, and child/adult and the like. Also, if the subject is a person, an image of a face for example is used for an attribute detection image for use in the detection of attributes. For example, the attribute detection block 102 compares the feature of a face prepared for each attribute with the feature of a face image given as an attribute detection image to extract attributes approximating in feature. The attribute detection block 102 outputs the extracted attributes as an attribute detection result. It should be noted that, in the above-mentioned example, the subject is a person; however, it is also practicable to apply the present embodiment to the cases where the subject is an animal or an automobile, for example. For example, if the subject is an automobile, is it practicable to detect attributes of a passenger car, truck, and a bus from the features of a car body image.

### (Function of the Locational Estimation Block 103 and Exemplary Configuration of the Locational Relation Database 104)

As described above, the attributes of a subject are entered into the locational estimation block 103 from the attribute detection block 102. The result of part detection is entered in the locational estimation block 103 from the part detection block 101. When the attributes of a subject and the result of part detection are entered, the locational estimation block 103 estimates the location of a part (hereafter referred to as an undetected part) not detected by the part detection block 101 on the basis of the location of a part (hereafter referred to as a detected part) detected by the part detection block 101). At this time, the locational estimation block 103 estimates the location of an undetected part by use of information (hereafter referred to as locational relation information) indicative of the locational relation between the parts stored in the locational relation database 104.

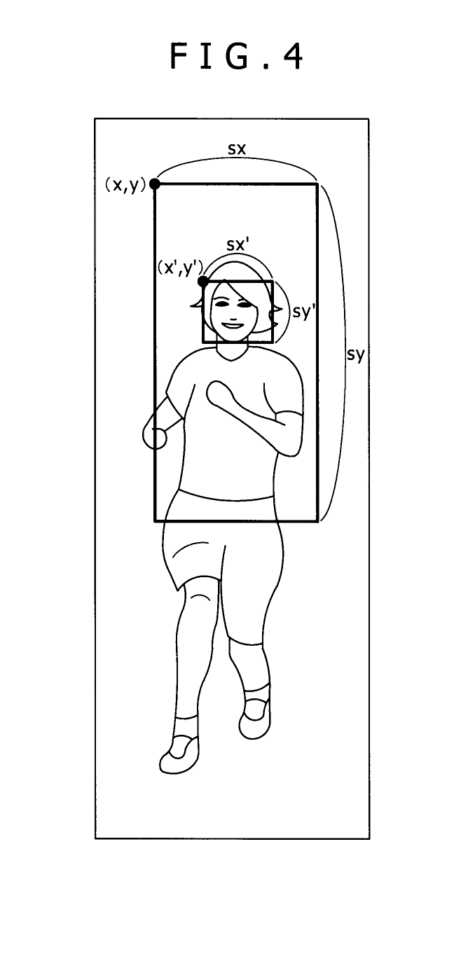

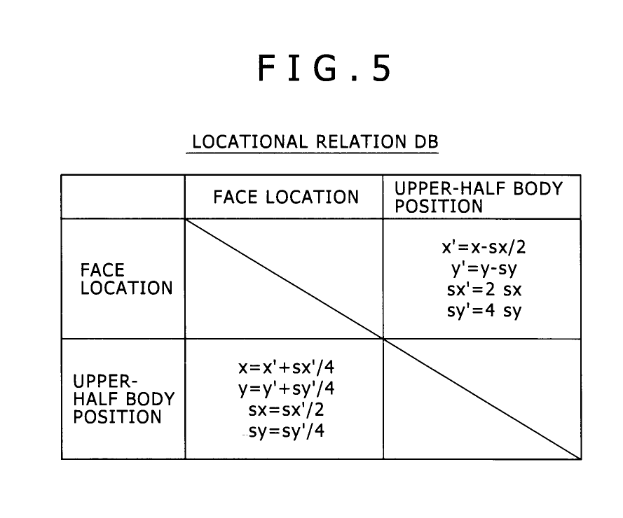

The following describes a location estimation method to be executed by the locational estimation block 103 with reference to FIG. 4 and FIG. 5. For one example, it is assumed that the detected part be the upper half body and the undetected part be a face. On this assumption, a method of estimating the location of a face from a detection result of the upper half body is described below.

First, referring to FIG. 4, there is drawn a person that is a subject. FIG. 4 also shows a frame enclosing the upper half body of the person and a frame enclosing the face of the person. The frame enclosing the upper half body of the person is indicative of the location of the detected part. The frame enclosing the face of the person is indicative of the location of the undetected part. Here, let the width, the height, and the coordinate of the left vertex of the frame enclosing the upper half body be sx, sy, and (x, y), respectively; and the width, the height, and the coordinate of the left vertex of the frame enclosing the face be sx′, sy′, and (x′, y′), respectively. Namely, it is assumed that as results of the detection of the upper half body by the part detection block 101, sx, sy, and (x, y) have been obtained in advance.

The locational estimation block 103 estimates sx′, sy′, and (x′, y′) from sx, sy, and (x, y). At this moment, the locational estimation block 103 references the contents (or locational relation information) of the locational relation database 104 as shown in FIG. 5. It should be noted that FIG. 5 shows equations indicative of the relation between the locations of upper half body and face; actually, the parameters necessary for the execution of the operations expressed by these equations may be stored in the locational relation database 104 in advance. For example, for equation x′=x=sx/2 for computing x′, sign “-” of the second term of the right side and “½” that is magnification factor sx may be stored in the locational relation database 104 as the parameter in advance. This hold true with other equations.

The locational estimation block 103 substitutes the upper half body detection results sx, sy, and (x, y) into the linear equations shown in FIG. 5 to obtain face estimation results sx′, sy′, and (x′, y′). It should be noted that the locational relation database 104 may be arranged for each of the attributes. For example, there are large differences in locational relations of upper half body and face between child and adult. Hence, in order to accurately estimate the location of an undetected part from the location of a detected part, it is desired to use the locational relation databases 104 that are different from attribute to attribute. If the locational relation databases 104 are arranged for the different attributes, the locational estimation block 103 references the locational relation database 104 corresponding to the attribute entered from the attribute detection block 102. Thus, the locational information indicative of the location of the undetected part estimated by the locational estimation block 103 and the location information indicative of the location of the detected part are outputted from the part detection apparatus 100. In addition, these pieces of information are entered in the identification information allocation block 106.

### (Function of the Locational Relation Update Block 105)

The following describes the updating of the locational relation database 104. In the above, description has been made on the assumption that the locational relation database 104 be prepared in advance. In the case where an image to be entered in the part detection apparatus 100 is a moving image frame, the locational relation database 104 can be updated by use of the locational relation of parts detected from a current moving image frame, thereby possibly enhancing the accuracy of the estimation of undetected parts in following moving image frames.

For example, the locations of a hand change for each moving image frames. However, between the moving image frames near to each other, the locations of a hand do not change so much. Therefore, updating, in advance, the locational relation database 104 on the basis of the locational relation information based on the hand locations detected in the moving image frames near to each other can enhance the estimation accuracy of undetected parts based on hand locations as compared with the use of the locational relation information based on predetermined hand locations. By reason of this, if there are two or more detected parts, the locational relation update block 105 sequentially updates the locational relation database 104 on the basis of the locational relation between these detected parts.

### (Function of the Identification Information Allocation Block 106)

The identification information allocation block 106 groups the parts of a same subject on the basis of the locational relation between the parts detected by the part detection block 101. Next, the identification information allocation block 106 allocates group IDs different for each subject for the parts belonging to a same group. Further, the identification information allocation block 106 allocates, to the part of which location has been estimated, the same group ID as that of the part used for this estimation. In addition, the identification information allocation block 106 allocates, to the part of which location has been detected by the part detection block 101 and the part of which location has been estimated by the locational estimation block 103, the part IDs different for different part types.

Therefore, each part is allocated with a group ID and a part ID as identification information. The identification information allocated to each part by the identification information allocation block 106 as described above is outputted from the part detection apparatus 100 along with the locational information of each part. It should be noted that the allocation of the identification information to each detected part may be executed before the completion of the estimation of an undetected part by the locational estimation block 103.

As described above, an exemplary functional configuration of the part detection apparatus 100 has been explained. As described above, if a part desired for detection could not be detected, the part detection apparatus 100 can estimate the location of this part from the location of another detected part. If an image to be entered is a moving image frame, the part detection apparatus 100 can sequentially update the locational relation database 104 by use of part detection results, thereby enhancing the estimation accuracy of undetected parts. Further, because the locational relation database 104 is arranged for each attribute, the part detection apparatus 100 can estimate the locations of undetected parts with a high accuracy.

### [1-2: Operations of the Part Detection Apparatus 100]

The following describes operations of the part detection apparatus 100 practiced as the present embodiment of the disclosure with reference to FIG. 6 and FIG. 7. FIG. 6 and FIG. 7 are flowcharts indicative of flows of the part detection processing and the part estimation processing to be executed by the part detection apparatus 100.

As shown in FIG. 6, first, an image is entered in the part detection apparatus 100 (S101). The image entered in the part detection apparatus 100 is further entered the two or more part detection blocks 101 and the attribute detection block 102. Next, when the image has been entered, the part detection block 101 detects a part of a subject from the entered image (S102). A result of the detection by the part detection block 101 is entered in the locational estimation block 103 and the locational relation update block 105. At the same time, a result of the detection associated with a predetermined part for use by attribute detection is entered in the attribute detection block 102.

Having received the detection result associated with a predetermined part and the image, the attribute detection block 102 extracts an image area of the predetermined part from the image on the basis of the entered detection result. Next, the attribute detection block 102 detects the attributes of the subject from the extracted image area (S103). The attributes detected by the attribute detection block 102 are entered in the locational estimation block 103 and the locational relation update block 105. Next, the identification information allocation block 106 groups the detected parts by subject and allocates different group IDs to different subjects for the detected parts (S104). Here, it is assumed that each part be allocated with a different part ID in advance.

Next, the part detection apparatus 100 starts a loop associated with group ID(n) (n=1, . . . , N). Further, the part detection apparatus 100 starts a loop associated with part ID(i) (i=1, . . . ). Then, the locational estimation block 103 determines whether the location of a part corresponding to part ID(i) has been detected or not (S105). If the location of a part corresponding part ID(i) is found to have been detected, then the part detection apparatus 100 advances the procedure to “A.” On the other hand, if the location of a part corresponding to part ID(i) is found to have not been detected, then the part detection apparatus 100 advances the procedure to “B.”

If the procedure goes to “A,” the part detection apparatus 100 starts a loop associated with part ID(j) (j=1, . . . , N) and advances the procedure to step S106 (FIG. 7). On the other hand, if the procedure goes to “B,” the part detection apparatus 100 increments part ID(i) and returns the procedure to step S105. If the procedure goes to step S106, then the locational estimation block 103 determines whether the location of a part corresponding to part ID(j) has been detected or not (S106). If the location of a part corresponding to part ID(j) is found to have been detected, then the part detection apparatus 100 advances the procedure to step S107. If the location of a part corresponding to part ID(j) is found to have not been detected, then the part detection apparatus 100 advances the procedure to step S108.

If the procedures goes to step S107, the locational relation update block 105 updates the locational relation information stored in the locational relation database 104 on the basis of the locational relation between the two parts corresponding to ID(i) and ID(j), respectively, detected by the part detection block 101 (S107). It should be noted that the locational relation information represents the coordinates, widths, and heights of the two parts in a linear equation as shown in FIG. 5. Hence, when the coordinates, widths, and heights of the two parts are found, a linear equation indicative of the locational relation between the two parts can be obtained. When the locational relation database 104 is updated by the locational relation update block 105, then the part detection apparatus 100 increments part ID(j) and returns the procedure to step S106.

On the other hand, if the procedure goes to step S108, then the locational estimation block 103 references the locational relation database 104 corresponding to the attribute detected by the attribute detection block 102 to estimate the location of an undetected part (a part corresponding to part ID(j)) (S108). When the location of the undetected part is estimated by the locational estimation block 103, then the part detection apparatus 100 increments part ID(j) and returns the procedure to step S106.

Having executed all processing operations of step S106, S107 or S108 for all part IDs(j), the part detection apparatus 100 advances the procedure to step S109. If the procedure goes to step S109, the locational estimation block 103 averages the locations of two or more parts estimated from the locations of different parts corresponding to the same part ID (S109). For example, the location of the face estimated from the upper half body differs from the location of the face estimated by the right hand. Hence, locational estimation block 103 averages these locations to compute one estimated location.

Next, the locational estimation block 103 holds the estimated location of an undetected part and the location of a detected part (S110). When the locations of these parts are held by the locational estimation block 103, the part detection apparatus 100 increments part ID(i) and returns the procedure to step S105. Having executed the processing operations of steps S105 through step S110 for all part IDs(i), the part detection apparatus 100 increments group ID(n) and repetitively executes the processing operations in the loop associated with part ID(i) again. Having executed the processing operations in the loop associated with part ID(i) for all group IDs(n), the part detection apparatus 100 outputs the location of each part as a processing result, thereby terminating the above-mentioned sequence of processing operations. It should be noted that the part detection apparatus 100 may also output the group ID and the part ID allocated to each part.

As described above, the operations to be executed by the part detection apparatus 100 practiced as the present embodiment have been explained. As described above, if a desired part could not be detected, the part detection apparatus 100 can estimate the location of the desired part from the location of a part that could be detected. In addition, if an image to be entered is a moving image frame, the part detection apparatus 100 can enhance the detection accuracy of undetected parts by sequentially updating the locational relation database 104 by use of the results of part detection. Further, because the locational relation database 104 is arranged for each attribute, the part detection apparatus 100 can estimate the locations of undetected parts with a high accuracy.

### [1-3: Exemplary Configuration and Operations of the Object Tracking Apparatus 10]

The following describes exemplary applications of the part detection apparatus 100. For example, the part detection apparatus 100 may be applied to the object tracking apparatus 10 configured to track an object (especially, a particular part) appearing in images continuously taken by imaging means or a moving image frame stored in storage means. It should be noted that term “track” herein denotes that an object appearing in continuously entered images is recognizes as the same image and a temporal locational change of this object is identified for each object.

For example, the object tracking apparatus 10 is installed on an imaging apparatus, such as a digital television camera and is used to track a part in attention, such as the face of a subject. Tracking of a part in attention allows automatic control such that a part in attention is always in focus and automatic control such that zooming is controlled to prevent the size of a part in attention from getting below a predetermined level. In addition, the object tracking apparatus 10 and imaging means may be installed on a device, such as a digital signage terminal or an automatic vending machine, to track a part in attention, thereby counting a duration of time in which a customer stays in front of the device. Such a function works only when the tracking of a part in attention is continuous. In this respect, the object tracking apparatus 10 to which the part detection apparatus 100 is applied can continuously track a part in attention by estimating the location thereof even if the part in attention cannot be detected by some reason.

Referring to FIG. 8, there is shown an exemplary configuration of the object tracking apparatus 10 practiced as the present embodiment. As shown in FIG. 8, the object tracking apparatus 10 has an image input block 11, an object tracking block 12, an output block 13, and the part detection apparatus 100. Here, it is supposed that images (or moving image frames) making a moving image be continuously entered in the object tracking apparatus 10 from the imaging means or the storage means.

When an image is entered in the object tracking apparatus 10, the image input block 11 enters the entered image into the part detection apparatus 100 and the output block 13. The part detection apparatus 100 in which the image has been entered detects or estimates the location of each part making up a subject from the entered image and outputs information of the detected or estimated location. In addition, the part detection apparatus 100 also outputs identification information, such as the group ID and part ID allocated to each part, along with this locational information. The locational information and the identification information outputted from the part detection apparatus 100 are entered in the object tracking block 12.

When the locational information and the identification information are entered in the object tracking block 12, the object tracking block 12 tracks the subject (or the object) or a particular part (or a part in attention) making up the subject on the basis of the entered locational information and identification information. In what follows, the description will be made assuming that the object tracking block 12 track a part in attention. The object tracking block 12 tracks a person's face on the basis of a tracking algorithm shown in FIG. 9, for example. As shown in FIG. 9, the object tracking block 12 first allocates an ID for tracking (hereafter referred to as a tracking ID) to a newly detected face (S301).

Next, the object tracking block 12 determines whether the area of the detected face satisfies conditions that the area of an undetected face overlaps with more than M % (M being a predetermined value) of the area of the face detected in the image one frame before and the size difference is less than L % (L being a predetermined value). If the detected face area is found to satisfy these conditions, then the object tracking block 12 allocates the tracking ID allocated to the face detected in the image one frame before to the face detected in the image of the current frame (S302). On the other hand, if the detected face area is found not to satisfy these conditions, then the object tracking block 12 sets the area of the face detected in the image one frame before to the area of the face in the image of the current frame and allocates the same tracking ID to the area of that face (S303). Further, if the face having the same tracking ID has not been detected for N seconds (N being a predetermined value), then the object tracking block 12 deletes this tracking ID (S304).

Managing tracking IDs as described above allows the object tracking block 12 to track the area of a face that appears in continuously entered images. It should be noted that, in the above description, a person's face is used for the part in attention, but other parts can be tracked in substantially the same manner. As shown in FIG. 8, results of the tracking by the object tracking block 12 are entered in the output block 13. The output block 13 outputs the received tracking results along with the images. For example, the output block 13 displays the areas of parts in attention included in the images in differently-colored frames for different tracking IDs. It should be noted that methods of displaying tracking results by the output block 13 are not limited to this method; for example, any other methods may be used as long as the areas of parts in attention are representable to the user for different tracking IDs.

As described above, an exemplary configuration and operations of the object tracking apparatus 10 have been explained for one application example of the part detection apparatus 100 practiced as the present embodiment. As described above, because the part detection apparatus 100 can estimate also the location of an undetected part, applying the part detection apparatus 100 to the tracking of parts in attention allows the stable tracking of parts in attention.

### [1-4: The First Variation (Stepwise Detection Processing)]

The following describes a variation (or the first variation) to the present embodiment. As described before, reasons why a part of a subject cannot be detected include the setting of parameters for determining detection accuracy, in addition to the blocking of the subject by some object, for example. As described before with reference to FIG. 2, the detection accuracy depends on parameters, such as the size of a face detection window (in the case of face detection) and the reduction factor of an image, for example. Setting the parameters so as to increase the detection accuracy increases the amount of computation required for the detection of a part. To be more specific, the detection accuracy and the computational amount are in a trade-off relation, so that a good balance must be considered between both the parameters.

So far, a method has been described in which the parameter setting for determining the detection accuracy is left unchanged and the location of an undetected part is estimated from the location of a detected part. The following describes a method of re-detecting the location of an undetected part with a higher accuracy by use of the results of the estimation of an undetected part. This method allows the realization of the part detection with a higher detection while preventing the increase in the computational amount. It should be noted that, in the application of this variation, the functional configuration of the part detection apparatus 100 described above is varies to a part detection apparatus 200 shown in FIG. 10.

### (1-4-1: Exemplary Functional Configuration of the Part Detection Apparatus 200)

First, an exemplary functional configuration of the part detection apparatus 200 associated with the present variation will be described with reference to FIG. 10. Referring to FIG. 10, there is shown a schematic diagram illustrating an functional configuration of the part detection apparatus 200 associated with the present variation.

As shown in FIG. 10, the part detection apparatus 200 is mainly configured by a two or more part detection blocks 201, a locational estimation block 202, and a locational relation database 203. It should be noted that the part detection apparatus 200 may have components corresponding to the attribute detection block 102, the locational relation update block 105, and the identification information allocation block 106 arranged in the part detection apparatus 100 described before. Further, the configuration of the locational relation database 203 is substantially the same as the configuration of the locational relation database 104 arranged in the part detection apparatus 100.

First, an image is entered in the part detection apparatus 200. The image entered in the part detection apparatus 200 is then entered in the two or more part detection blocks 201. Each of these part detection blocks 201 detects the location of a part from the entered image. It should be noted that the detection method to be executed by the part detection block 201 is substantially the same as the detection method to be executed by the part detection block 101 arranged in the part detection apparatus 100. A result of the part detection executed by the part detection block 201 is entered in the locational estimation block 202. Having received the result of part detection, the locational estimation block 202 references the locational relation database 203 to estimate the location of an undetected part from the location of the detected part. Next, the locational estimation block 202 enters an estimation result indicative of the estimated location of an undetected part into the part detection block 201 corresponding to that undetected part.

The part detection block 201 in which the estimation result has been entered executes the re-detection of a part by use of parameters having a higher detection accuracy on the area having a predetermined size including the location of an undetected part indicated by the entered estimation result. A result of the re-detection executed by the part detection block 201 is entered in the locational estimation block 202. Having received the re-detection result, the locational estimation block 202 estimates the location of an undetected part as required and outputs, outside of the part detection apparatus 200, the locational information indicative of the location of the detected part and the locational information indicative of the location of an undetected part estimated as required.

As described above, an exemplary functional configuration of the part detection apparatus 200 associated with the present variation has been explained. As described above, the part detection apparatus 200 associated with the present variation is characterized by the re-detection of an area including the location of an undetected part estimated by the locational estimation block 202 by use of parameters having a higher detection accuracy. Thus, executing the processing of the re-detection having a large computational amount within a limited area can prevent the computational amount from getting increased. In addition, the probability of detecting undetected parts goes up by re-detecting areas having a high probability of detecting undetected parts by use of parameters having a high detection accuracy.

### (1-4-2: Operations of the Part Detection Apparatus 200)

The following describes operations to be executed by the part detection apparatus 200 associated with the present variation with reference to FIG. 11. FIG. 11 is a flowchart indicative of operations (especially, a flow of re-detection processing) to be executed by the part detection apparatus 200.

As shown in FIG. 11, first, an image is entered in the part detection apparatus 200 (S201). Having received the image, the part detection apparatus 200 detects the location of a part by use of the function of the part detection block 201 and, for an undetected part, estimates the location thereof by the use of the function of the locational estimation block 202 (S202). Next, the part detection apparatus 200 executes the detail detection of a part by use of the function of the part detection block 201 on the neighborhood of the location of a undetected part estimated by the function of the locational estimation block 202 (S203). Then, the part detection apparatus 200 outputs the locational information of the detected part and the locational information of the estimated location of an undete-cte-d part, as detection results (S204), thereby terminating the above-described sequence of processing operations.

As described, the operations to be executed by the part detection apparatus 200 associated with the present variation have been explained. As described above, executing the re-detection by use of parameters of a higher detection accuracy on the neighborhood of the location of an undetected part estimated by the locational estimation block 202 allows the detection of a part with a higher detection accuracy while preventing a computational amount for the part detection from getting increased.

### [1-5: The Second Variation (the Part Estimation by Two or More Parts)]

The following describes another variation (the second variation) to the present embodiment. So far, the description has been made by supposing the estimation of one undetected part from the location of one detected part (refer to FIG. 4 and FIG. 5 for example). However, in case where there are two or more detected parts, it is expected to increase the estimation accuracy if the location of one undetected part can be estimated from the locations of two or more detected parts. The following describes, as the second variation, a method of estimating the location of one undetected part from the locations of two or more detected parts.

### (1-5-1: Overview of an Estimation Method)

Suppose a method of estimating the location of a person's upper half body from the locations of both legs, for example. As shown in FIG. 12, let the coordinates indicative of the right leg be (xᵣ, yᵣ), the width thereof be sxᵣ, and the height thereof be syᵣ; likewise, let the coordinates indicative of the location of the left leg be (x₁, yₗ), the width thereof be sxₗ, and the height thereof be syl. Further, let the coordinates indicative of the location of the upper half body be (x, y), the width thereof be sx, and the height thereof be sy. In this example, the contents of a locational relation database 104 for use in the estimation of the location of the upper half body are expressed as equations (1) through (4) shown below, for example. It should be noted that the locational relation database 104 may hold “a,” “b,” “c,” “d,” and “e” with the locational relation information noted as sx=a*(sxᵣ+sxₗ), sy=b*(syᵣ+syₗ), x=c*(xᵣ+x₁)+d*sx, y=e*(yᵣ yₗ)+e*sy.

sx=(½)*(sxᵣ+sx₁) (1)

sy=(¾)*(syᵣ+syₗ) (2)

x=(xᵣ+x₁)/2 (3)

y=(yᵣ+yₗ)/2+sy (4)

### (1-5-2: Flow of Part Estimation Processing)

The following describes flows of the part detection processing including the part estimation processing associated with the present variation with reference to FIG. 13 through FIG. 15. FIG. 13 through FIG. 15 are flowcharts indicative of the flows of the part detection processing including the part estimation processing associated with the present variation. It is assumed here that the part estimation processing be executed by the part detection apparatus 100 described before.

As shown in FIG. 13, first, an image is entered in the part detection apparatus 100 (S401). The image entered in the part detection apparatus 100 is then entered in the two or more part detection blocks 101 and the attribute detection block 102. Next, having received the image, the part detection block 101 detects parts of the subject from the entered image (S402). A detection result obtained by the part detection block 101 is entered in the locational estimation block 103 and the locational relation update block 105. A detection result associated with predetermined parts for use in attribute detection is entered in the attribute detection block 102.

The attribute detection block 102 in which the detection result associated with the predetermined parts and the image have been entered extracts an image areas of the predetermined parts from the image on the basis of the entered detection result. Next, the attribute detection block 102 extracts attributes of the subject from the extracted image areas (S403). The attributes extracted by the attribute detection block 102 are entered in the locational estimation block 103 and the locational relation update block 105. Next, the identification information allocation block 106 groups the detected parts by subject and allocates different group IDs for different subjects to the detected parts (S404). It is assumed that each part is allocated with a different part ID in advance.

Next, the part detection apparatus 100 starts a loop associated with group ID(n) (n=1, N). Further, the part detection apparatus 100 starts a loop associated with part ID(i) (i=1, . . . ). Then, the locational estimation block 103 determines whether the locations of the parts corresponding to part ID(i) have been detected or not (S405). If the locations of the parts corresponding to part ID(i) are found to have been detected, then the part detection apparatus 100 advances the procedure to “A.” On the other hand, if the locations of the parts corresponding to part ID(i) are found to have not been detected, then the part detection apparatus 100 advances the procedure to “B.”

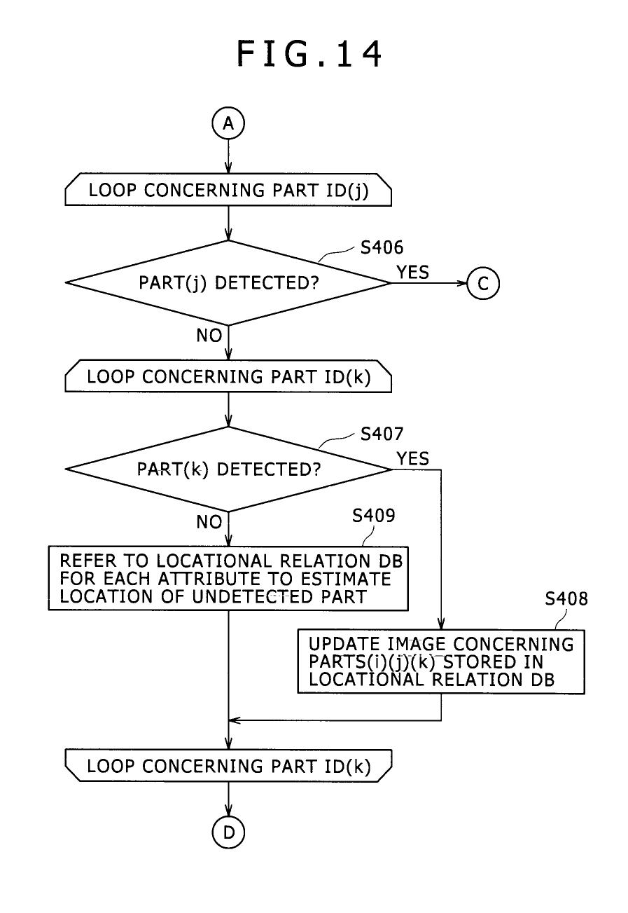

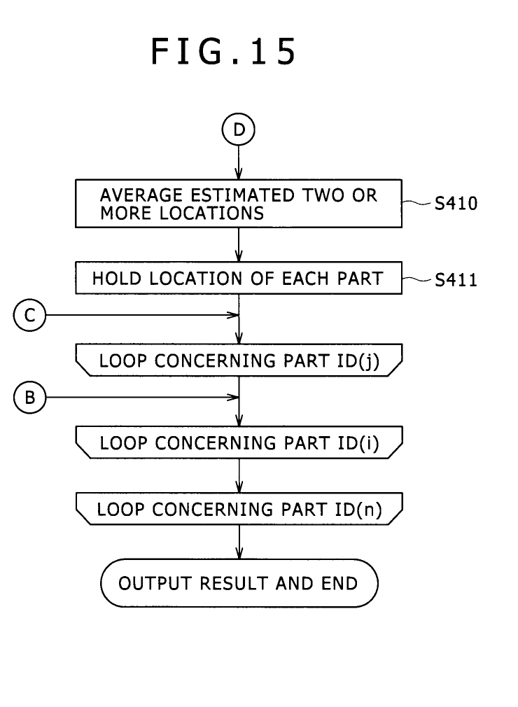

If the procedure is advanced to “A,” then the part detection apparatus 100 starts a loop associated with part ID(j) (j=1, . . . ) and advances the procedure to step S406 (FIG. 14). On the other hand, if the procedure is advanced to “B” (FIG. 15), then the part detection apparatus 100 increments part ID(i) and returns the procedure to step S405. If the procedure is advanced to step S406, the locational estimation block 103 determines whether the location of the part corresponding to part ID(j) has been detected or not (S406). If the location of the part corresponding to part ID(j) is found to have been detected, then the part detection apparatus 100 starts a loop associated with part ID(k) (k=1, . . . ) and advances the procedure to step 5407. On the other hand, If the location of the part corresponding to part ID(j) is found to have not been detected, then the part detection apparatus 100 advances the procedure to “C.”

If the procedure is advanced to “C,” then the part detection apparatus 100 increments part ID(j) and returns the procedure to step S406. On the other hand, if the procedure is advanced to step S407, then the locational estimation block 103 determines whether the location of the part corresponding to part ID(k) has been detected or not (S407). If the location of the part corresponding to part ID(k) is found to have been detected, then the part detection apparatus 100 advances the procedure to step S408. On the other hand, if the location of the part corresponding to pat ID(k) is found to have not been detected, the part detection apparatus 100 advances the procedure to step S409.

If the procedure is advanced to step S408, the locational relation update block 105 updates the locational relation information stored in the locational relation database 104 on the basis of the locational relation of the parts corresponding to part IDs(i), (j), and (k) detected by the part detection block 101 (S408). When the locational relation database 104 has been updated by the locational relation update block 105, then the part detection apparatus 100 increments part ID(k) and returns the procedure to step S407.

On the other hand, if the procedure is advanced to step S409, the locational estimation block 103 references the locational relation database 104 corresponding to the attributes detected by the attribute detection block 102 to estimate the location of an undetected part (a part corresponding to part ID(k)) from the location of the detected part (S409). When the location of an undetected part has been estimated by the locational estimation block 103, then the part detection apparatus 100 increments part ID(i) and returns the procedure to step S407.

When the processing operations of step S407 and S408 or S409 have all been executed on all part IDs(k), the part detection apparatus 100 advances the procedure to “D.” If the procedure is advanced to “D” (FIG. 15), the locational estimation block 103 averages the locations of the two or more parts estimated from a set of the locations of different parts corresponding to the same part ID (S410). Next, the locational estimation block 103 holds the estimated location of an undetected part and the locations of the detected parts (S411). When the locations of the parts are held by the locational estimation block 103, the part detection apparatus 100 increments part ID(i) and returns the procedure to step S405.

When the processing operations of step S405 through step S411 have been repetitively executed on all part IDs(i), the part detection apparatus 100 increments group ID(n) and repetitively executes the processing operations in the loop associated with part ID(i) again. When the processing operations in the loop associated with part ID(i) have been repetitively executed on all part IDs(n), the part detection apparatus 100 outputs the locations of the parts as detection results and terminates the above-described sequence of processing operations. It should be noted that the part detection apparatus 100 may output the group ID and the part ID allocated to each of the parts along with the detection results.

As described above, the flows of the part detection processing including the part estimation processing associated with the second variation have been explained. As described above, estimating the location of one undetected part from the locations of two or more detected parts can enhance the estimation accuracy for the undetected part.

### 2: Exemplary Hardware Configuration

The functions of the components of the part detection apparatus 100, the part detection apparatus 200, and the object tracking apparatus 10 can be realized by use of the hardware configuration of an information processing apparatus shown in FIG. 16, for example. To be more specific, the functions of these components can be realized by controlling the hardware shown in FIG. 16 by a computer program. It should be noted that this hardware can take any desired form and therefore include a personal computer, a portable information terminal such as a mobile phone, a PHS, or a PDA, a game machine, and various information household appliances, for example. PHS is short for Personal Handy-phone System. PDA is short for Personal Digital Assistant.

As shown in FIG. 16, this hardware mainly has a CPU 902, a ROM 904, a RAM 906, a host bus 908, and a bridge 910. In addition, this hardware has an external bus 912, an interface 914, an input block 916, and output block 918, a storage block 920, a drive 922, a connection port 924, and a communication block 926. CPU is short for Central Processing Unit. ROM is short for Read Only Memory. RAM is short for Random Access Memory.

The CPU 902 functions as a computation processing apparatus or a control apparatus and controls all or part of operations of the components on the basis of various programs stored in the ROM 904, the RAM 906, the storage block 920, or a removable recording media 928. The ROM 904 provides means for storing programs and data for computation that are read by the CPU 902. The RAM 906 temporarily or permanently stores programs to be read by the CPU 902 and various parameters that change from time to time when these programs are executed.

The above-mentioned components are interconnected via the host bus 908 configured to execute fast data transfer. On the other hand, the host bus 908 is connected, via the bridge 910, to the external bus configured to execute comparatively slow data transfer. The input block 916 is based on a mouse, a keyboard, a touch panel, buttons, switches, and levers, for example. Further, the input block 916 may be a remote controller configured to transmit control signals on the basis of infrared ray or electromagnetic wave.

The output block 918 is based on a display apparatus such as CRT, LCD, PDP, or ELD, an audio output apparatus such as loudspeaker or headphone, a printer, a mobile phone, or a facsimile, for example, that present obtained information to the user in a visual or audible manner. CRT is short for Cathode Ray Tube, LCD is short for Liquid Crystal Display. PDP is short for Plasma Display Panel. ELD is short for Electro-Luminescence Display.

The storage block 920 stores various kinds of data. The storage block 920 is based on a magnetic storage device such as HDD, a semiconductor storage device, an optical storage device, or a magneto-optical storage device, for example. HDD is short for Hard Disk Drive.

The drive 922 reads information from the removable recording media 928 such as magnetic disk, optical disk, magneto-optical disk, or a semiconductor memory, for example, that is loaded on the drive 922 or write information to the loaded removable recording media 928. The removable recording media 928 is based on DVD media, Blu-ray media, HD DVD media, or various kinds of semiconductor media, for example. Obviously, the removable recording media 928 may be an IC card having a non-contact IC chip or an electronic device, for example. IC is short for Integrated Circuit.

The connection port 924 is a port such as USB port, IEEE 1394 port, SCSI port, RS-232C port, or optical audio terminal for connecting an externally connected device. The externally connected device 930 is a printer, a portable music player, a digital camera, a digital video camera, or an IC recorder, for example. USB is short for Universal Serial Bus. SCSI is short for Small Computer System Interface.

The communication block 926 is a communication device for making connection to a network 932 and is based on wired or wireless LAN, Bluetooth (trademark), or WUSB communication card, optical communication router, ADSL router, or any of various communication modems, for example. The network 932 connected to the communication block 926 is configured by a network connected in a wired or wireless manner and is based on the Internet, household LAN, infrared communication, visible light communication, broadcasting, or satellite communication, for example. LAN is short for Local Area Network. WUSB is short for Wireless USB. ADSL is short for Asymmetric Digital Subscriber Line.

### 3: Summary

The following summarizes the contents of technologies associated with the embodiments of the present disclosure. The technological contents to be described below are applicable to various apparatuses such as PC, mobile phone, portable game machine, portable information terminal, information household appliance, car navigation system, digital still camera, digital video camera, digital signage terminal, ATM (Automated Teller Machine), automatic vending machine, and so on, for example.

The above-mentioned embodiments of the present disclosure are associated with a part detection apparatus having a part detection block configured to detect the locations of two or more parts making up a subject. This part detection apparatus is installable on various apparatuses as described above. In addition, if the location of a part in attention has not been detected by the part detection block, this part detection apparatus has a part-in-attention estimation block configured to estimate the location of the part in attention on the basis of the location of the part detected by the part detection block and the information about the locational relation with this location of the detected part being used as reference. This arrangement of the part-in-attention estimation block allows the part detection apparatus to recognize the location of the part in attention even if the part in attention has not been detected by the part detection block by some reason.

For example, use of a related-art face detection technology allows the detection of the location of a face from an input image. However, in such a related-art face detection technology, a face directed in the front can be accurately detected but it is difficult to detect a face directed sideways, for example. In addition, this related-art face detection technology frequently fails the detection of a face if it is hidden by a hand or attached with eye glasses, for example. On the other hand, if the location of a part other than the face, such as the location of the upper half body or the location of one hand, has already been detected, the above-described part detection apparatus practiced as one embodiment of the present disclosure can estimate the location of a face that is a part in attention from the location of the already detected part. Hence, the novel part detection apparatus can recognize the location of a face if the face is hidden by a hand or attached with eye glasses or directed sideways. In tracking the location of a face appearing in a moving image, for example, use of this novel part detection apparatus can continuously track the face because the location of the face has been estimated from other parts if a frame in which the face is hidden by a hand is included.

It should be noted that the locational estimation block 103 described above is one example of the part-in-attention estimation block. The locational relation update block 105 described above is one example of the information update block. The object tracking block 12 described above is one example of the tracking block.

While preferred embodiments of the present disclosure have been described using specific terms, such description is for illustrative purpose only, and it is to be understood that changes and variations may be made without departing from the spirit or scope of the following claims.

The present disclosure contains subject matter related to that disclosed in Japanese Priority Patent Application JP 2010-260194 filed in the Japan Patent Office on Nov. 22, 2010, the entire content of which is hereby incorporated by reference.

What is claimed is:

1. A part detection apparatus comprising:
a part detection block configured to detect a location of a plurality of parts making up a subject from an input image; and
a part-in-attention estimation block configured, if a location of a part in attention has not been detected by said part detection block, to estimate said location of a part in attention on the basis of said location of a part detected by said part detection block and information about a locational relation with said detected location of a part being used as reference.

2. The part detection apparatus according to claim 1, further comprising:
an information update block configured, if said location of a part in attention and a location of a part different from said part in attention have been detected by said part detection block, to update said information about a locational relation on the basis of said location of a part in attention and said location of another part.

3. The part detection apparatus according to claim 2, wherein said part detection block detects said locations of a plurality of parts with a first accuracy and, if said location of a part in attention has not been detected, detects said location of a plurality of parts with a second accuracy higher than said first accuracy for an area having a predetermined size including said location of a part in attention estimated by said part-in-attention estimation block.

4. The part detection apparatus according to claim 3, further comprising
an identification information allocation block configured to allocate different identification information for each of said subjects to the parts of which locations have been detected by the part detection block, wherein
said identification information allocation block allocates substantially the same identification information as the identification information allocated to the part used for estimation to said part in attention of which location has been estimated by said part-in-attention estimation block.

5. The part detection apparatus according to claim 4, wherein
said input image is a frame making up a moving image and
said part detection apparatus further includes a tracking block configured to track said location of a part in attention.

6. The part detection apparatus according to claim 1, wherein, if said location of a part in attention has not been detected by said part detection block but locations of a plurality of parts different from said part in attention have been detected, then said part-in-attention estimation block estimates said location of a part in attention on the basis of said locations of a plurality of parts detected by said part detection block and information about a locational relation with said detected locations of a plurality of parts being used as reference.

7. The part detection apparatus according to claim 1, further comprising:
an attribute detection block configured to detect attributes of said subject from a predetermined part detected by said part detection block, wherein
said part-in-attention estimation block references said information about a locational relation prepared for each of said attributes to estimate said location of a part in attention on the basis of said information about locational relation corresponding to said attribute of said subject detected by said attribute detection block.

8. A part detection method comprising:
detecting a location of a plurality of parts making up a subject from an input image; and
estimating, if a location of a part in attention has not been detected by said part detection block, said location of a part in attention on the basis of said location of a part detected by said part detection block and information about a locational relation with said detected location of a part being used as reference.

9. A program for causing a computer to realize the functions of:
detecting a location of a plurality of parts making up a subject from an input image; and
estimating, if a location of a part in attention has not been detected by said part detection block, said location of a part in attention on the basis of said location of a part detected by said part detection block and information about a locational relation with said detected location of a part being used as reference.
